(19) United States
(12) Patent Application Publication
(10) Pub. No.: US 2006/0002754 A1
(43) Pub. Date: Jan. 5, 2006

(54) Lipstick applicator and distributor comprising said applicator

(76) Inventor: Fabrice Dieudonat, Fosses (FR)

Correspondence Address: YOUNG & THOMPSON, 745 SOUTH 23RD STREET, 2ND FLOOR, ARLINGTON, VA, 22202, US

(21) Appl. No.: 11/154,642

(22) Filed: Jun. 17, 2005

(30) Foreign Application Priority Data
Jun. 17, 2004 (FR) 04 06582

(51) Int. Cl. B43K 21/08

(52) U.S. Cl. 401/75

(57) ABSTRACT

An applicator comprises a tubular body (5) containing lipstick ending in an openwork application surface (7) in the form of a cylindrical section which curves inwardly from the side of the tubular body with a radius of curvature in the range 10 mm to 30 mm.

The present invention relates to an applicator for lipstick which is in the form of a paste. Said applicator is intended to cooperate with a reservoir containing the lipstick and comprising a mechanism for manually propelling the lipstick towards the applicator.

Known lipsticks are in the form of sticks having sufficient mechanical strength to allow their direct application to a person's lips.

The present invention provides an applicator for lipstick which is in the form of a paste, the lipstick in such a case having to be applied indirectly via an applicator because of the absence of mechanical strength of the lipstick itself.

The technical problem to be solved is to provide an applicator which is cheap to manufacture and assemble, which can deliver the lipstick to a person's lips in a homogeneous manner, and which has ergonomic characteristics, facilitates application, and provides excellent quality of the result obtained after application of the lipstick to the lips.

To this end, the applicator comprises a tubular body containing lipstick terminating in an openwork application surface in the form of a cylindrical section which curves inwardly in the direction of the tubular body with a radius of curvature in the range 10 to 30 mm.

The inwardly curved shape from the side to the interior of the application surface means that it is adapted to the shape of the lips.

Further, the application surface is inclined with respect to a plane perpendicular to the axis of the tubular body and forms an angle in the range 20° to 50° with respect to said plane. This characteristic facilitates manipulation of the applicator during application, allowing an excellent grip of the applicator support.

To allow the contour of the lips to be outlined neatly, the end of the application surface furthest from the tubular body is pointed.

To ensure optimum lipstick application conditions, the application surface is sized/shaped to allow it to be inscribed within the surface defined by two superimposed disks of 5 mm and 15 mm respectively.

The application surface may, for example, have the general form of a triangle with outwardly turned rounded sides, or a generally oval shape.

Depending on the fluidity, texture and colour of the lipstick, the application surface comprises orifices for the passage of lipstick with a total surface area in the range 10% to 50% of the application surface.

Different structures are possible for the application surface.

In a first embodiment, the application surface comprises solid bars disposed in two perpendicular directions and defining elongate orifices.

In a further embodiment, the application surface comprises two series of teeth in the form of combs which face each other, separated by a central slot.

In a still further embodiment, the application surface is constituted by a continuous wall in which holes are formed.

In this case, advantageously, certain holes are connected by grooves which do not open onto said reservoir, said grooves filling with lipstick to be applied to form zones for transitional storage and application of the lipstick. In accordance with one feature of the invention, said grooves are in the range 0.2 to 1 mm deep and in the range 0.4 to 2 mm wide.

In a yet still further embodiment, the application surface may comprise a plurality of longitudinal bars defining a plurality of longitudinal slots.

In a still further embodiment constituting a variation of the foregoing, the application surface may comprise a plurality of transverse bars defining a plurality of transverse slots.

This applicator may be produced from a synthetic material and obtained in a single piece. To provide a good touch sensation on the lips, the synthetic material used may be semi flexible or flexible; for example it may be formed from an elastomer.

To allow the lipstick to be seen, the applicator may be formed from transparent or translucent synthetic material. It is also possible to produce the applicator from a hard, transparent and flocked synthetic material.

The invention also concerns a lipstick distributor comprising a reservoir for lipstick in paste form, provided with an applicator as defined above.

In said lipstick distributor, the applicator may comprise a lower end forming a flange having the same diameter as said distributor reservoir.

The lipstick distributor of the invention may comprise a cap that typically cooperates in a sealed manner with said applicator or said reservoir.

Said cap, and typically the lower end of its skirt, may come into contact against said flange when said cap cooperates with said applicator in a manner which is typically sealed to prevent the lipstick from drying out.

The distributor may comprise various types of applicator and reservoir assemblies and in particular a means for axial snap-fitting of the applicator and the reservoir. In fact, the applicator may advantageously be assembled on the reservoir by axial snap-fitting, once the reservoir has been filled with lipstick.

The invention will be better understood from the following description made with reference to the accompanying figures showing non limiting examples of a number of embodiments of said applicator.

FIG. 1 is a perspective view of a device for applying a lipstick provided with a first applicator.

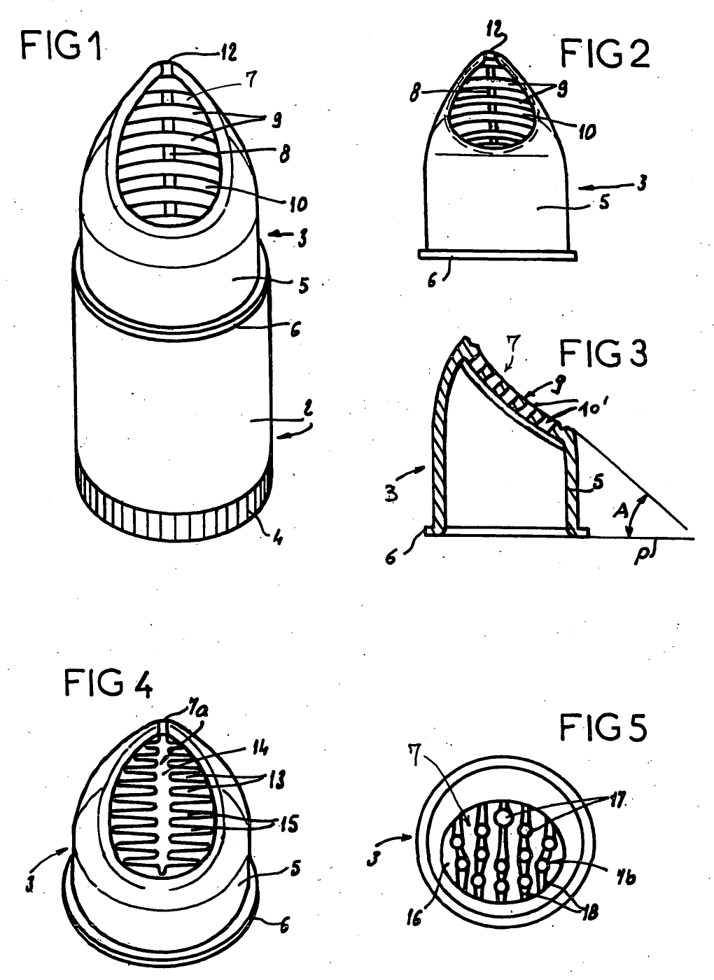

FIG. 2 is a side view of the applicator of FIG. 1.

FIG. 3 is a longitudinal cross sectional view.

FIG. 4 is a perspective view of a second embodiment of the applicator.

FIG. 5 is an end view of a third embodiment of said applicator.

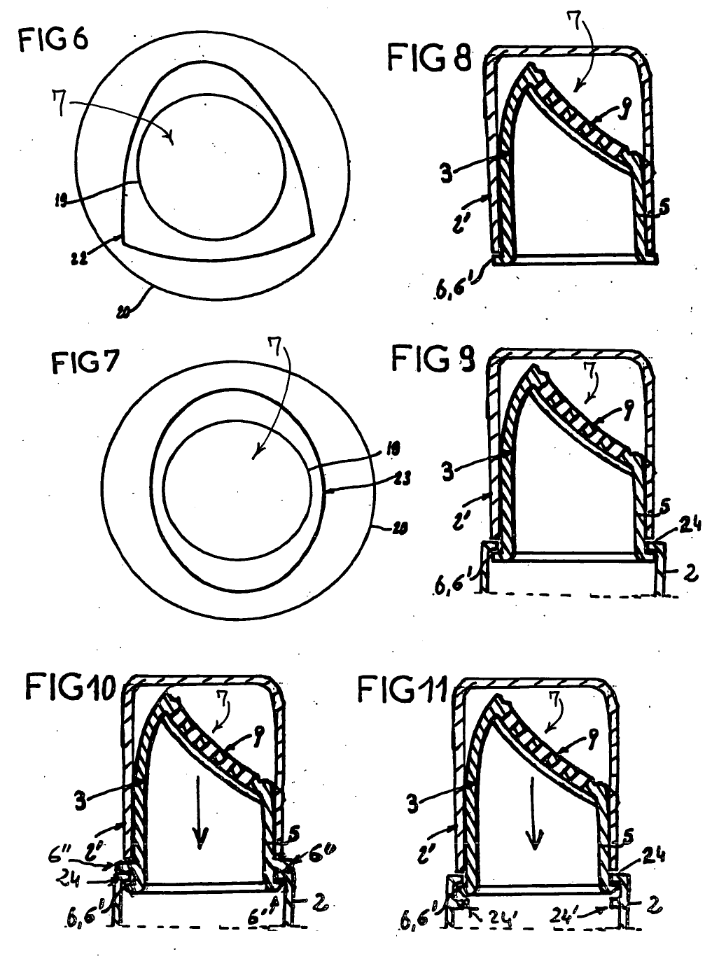

FIGS. 6 and 7 are two highly diagrammatic views showing two geometric shapes which may be employed for the applicator of the invention.

FIG. 8 is a view analogous to FIG. 3 illustrating the sealed cooperation of a cap with an applicator.

FIG. 9 is a partial view of a lipstick distributor analogous to that of FIG. 8 illustrating a mode of cooperation between the applicator and the distributor reservoir.

FIG. 10 is a view analogous to FIG. 9 which illustrates a further mode of cooperation between the applicator and the distributor reservoir.

FIG. 11 is a view analogous to FIG. 10 which illustrates a further mode of cooperation between the applicator and the distributor reservoir.

FIG. 1 shows a device for applying lipstick in the form of a paste, comprising a reservoir 2 at one end of which an applicator 3 is mounted. The end of the reservoir 2 opposite to that equipped with the applicator comprises a milled ring 4 which can compress the lipstick to make it move towards the applicator and to bring a sufficient quantity of lipstick to the applicator to apply it to a person's lips. Said compressing device is of known type and may, for example, employ a piston cooperating with a screw which is integral with said milled ring 4.

In the embodiment shown in FIGS. 1 to 3, the applicator 3 comprises a tubular body 5 one end 6 of which forms a flange 6′ and is intended to be connected in a sealed manner to the reservoir 2, and the other end of which comprises an application surface 7. Said application surface 7 is inclined with respect to a plane P perpendicular to the axis of the tubular body, forming an angle A in the range 20° to 50° with said plane.

As shown in particular in FIG. 3, the application surface 7 is in the form of a cylindrical section, curved inwardly from the side of the tubular body and with a radius of curvature in the range 10 to 30 mm.

In the embodiment shown in FIGS. 1 and 2, the application surface is defined by parallel transverse bars 9 and by a longitudinal bar 8. The bars 8 and 9 define orifices 10 of generally rectangular shape. It should be noted that the end of the application surface 7 which is furthest from its end 6 for connection to the reservoir 2 forms a point 12, facilitating clean outlining of the lip contours. The embodiment of FIG. 3 does not comprise a longitudinal bar 8, so the plurality of transverse bars 9 defines a plurality of transverse slots 10′. In the applicator of the embodiment of FIG. 3, the application surface comprises a plurality of transverse bars 9 defining a plurality of longitudinal slots 10′.

In a further embodiment analogous to that of FIG. 3, not shown by a figure, the application surface may be defined by a plurality of longitudinal bars defining a plurality of longitudinal slots, said longitudinal bars being bars orientated at 90° with respect to said transverse bars. In this applicator, the application surface comprises a plurality of transverse bars 8 defining a plurality of transverse slots.

FIG. 4 shows a variation of the applicator of FIGS. 1 to 3 in which the same elements are designated by the same reference numerals. In this case, the application surface 7a comprises two series of teeth 13 facing each other forming two combs defining a central slot 14. Two adjacent teeth 13 themselves define a slot 15.

FIG. 5 shows another embodiment in which the application surface 7b is defined by a continuous wall 16 in which holes 17 are formed, some of said holes, which may have different sizes, being connected together by non opening grooves 18 to temporarily trap said product on the application surface.

The grooves may in general have a depth in the range 0.2 to 1 mm and a width in the range 0.4 to 2 mm.

As can be seen in the drawing, the applicator may be produced in a single piece, for example from a synthetic material, obtained by moulding. The thickness of the portion of the applicator forming said perforated application surface 7 may generally be 1 mm to 3 mm, typically 1.5 mm to 2.5 mm.

FIGS. 6 and 7 show two possible forms of application surfaces. In both cases, the application surface is inscribed in a surface which is in the range between an inner circle 19 with a diameter of 5 mm and an outer circle 20 with a diameter of 15 mm. In the embodiment shown in FIG. 6, the application surface has an outline 22 which is generally triangular in shape, the sides of the triangle being curved and turned outwardly. In the shape shown in FIG. 7, the outline 23 has a generally oval shape.

FIG. 8 shows an example of sealed cooperation of a cap 2′ with the applicator 3, the lower end of the skirt of the cap 2′ abutting against the flange 6′ of the applicator 3. The skirt of the cap and the body 5 may include snap-fit means, typically formed by the cooperation of two complementary elements, generally in the form of a groove and a rib, one of the elements being carried by said skirt, and the other by said body 5.

FIG. 9 shows a mode of the distributor in which said reservoir 2 comprises a radial projection 24 cooperating with said flange 6′ to fix said applicator to said reservoir 2.

FIG. 10 shows a distributor having a variation of the applicator 3 in which the applicator 3 comprises two flanges, a lower flange 6′ and an upper flange 6″ which are axially offset to lock the radial projection 24 by axial snap-fitting of an assembly formed by the applicator 3 and its cap 2′ on the reservoir, once the latter is filled from the top. In this mode of the axial snap-fit means, the lower flange 6′ typically forms a bevel to facilitate irreversible snap-fitting of the applicator 3 to the reservoir 2, said axial snap-fitting being indicated by an arrow in FIG. 10.

FIG. 11 shows a distributor with a variation of the reservoir 2 in which the reservoir 2 comprises two radial projections, an upper radial projection 24 and a lower radial projection 24′, which can lock the flange 6′ of the applicator by axial snap-fitting an assembly formed by the applicator 3 and its cap 2′ on the reservoir once the latter is filled from the top. In this axial snap-fitting mode, the flange 6′ typically forms a bevel to facilitate irreversible snap-fitting of the applicator 3 to the reservoir 2.

Regardless of the embodiment of the applicator of the invention, said application surface (7, 7a, 7b) comprises orifices (10, 10′, 14, 15, 17) for passage of a paste product, namely the lipstick, which orifices form a direct passage between said reservoir and said application surface, the orifices being free of closing means or valves. Contrary to what might be expected, the applicant has observed that it is not necessary to provide these orifices with valves or equivalent means because the lipstick which is packaged in accordance with the invention, while being relatively fluid, is paste-like in nature and has a certain stiffness at rest. Thus, applicators of the invention are relatively simple pieces which are easy and cheap to mould. Furthermore, they are easy to assemble on a body or reservoir of the distributor.

As can be seen from the foregoing, the invention provides a perfect solution to the problem of applying a lipstick in the form of a paste.

Clearly, the invention is not limited to the embodiments of the lipstick applicator described above by way of example; on the contrary, its scope encompasses many variations.

1. An applicator for lipstick in the form of a paste, characterized in that it comprises a tubular body (5) containing lipstick terminated by an openwork application surface (7) in the form of a cylindrical section which curves inwardly in the direction of the tubular body with a radius of curvature in the range 10 to 30 mm.

2. A lipstick applicator according to claim 1, characterized in that the application surface (7) is inclined with respect to a plane (P) perpendicular to the axis of the tubular body and forms an angle (A) in the range 200 to 500 with said plane.

3. A lipstick applicator according to claim 2, characterized in that the end (12) of the application surface (7) which is furthest from the tubular body (5) is pointed.

4. A lipstick applicator according to claim 1, characterized in that the shape of the application surface is such that it can be inscribed in the surface defined by two superimposed disks (19, 20) of 5 mm and 15 mm respectively.

5. A lipstick applicator according to claim 1, characterized in that the application surface has the general form of a triangle (22) with outwardly turned rounded edges.

6. A lipstick applicator according to claim 1, characterized in that the application surface has a generally oval shape (23).

7. A lipstick applicator according to claim 1, characterized in that the application surface (7, 7a, 7b) has orifices (10, 10′, 14, 15, 17) for passage of lipstick with a total surface area in the range 10% to 50% of the application surface area.

8. A lipstick applicator according to claim 1, characterized in that the application surface (7) comprises solid bars (8, 9) disposed along two perpendicular directions and defining elongate orifices (10).

9. A lipstick applicator according to claim 1, characterized in that the application surface comprises a plurality of transverse bars (9) defining a plurality of transverse slots (10′).

10. A lipstick applicator according to claim 1, characterized in that the application surface comprises a plurality of longitudinal bars (8) defining a plurality of longitudinal slots.

11. A lipstick applicator according to claim 1, characterized in that the application surface (7a) comprises two series of teeth (13) in the form of facing combs separated by a central slot (14).

12. A lipstick applicator according to claim 1, characterized in that the application surface is constituted by a continuous wall (16) in which holes are formed (17).

13. A lipstick applicator according to claim 12, characterized in that some of the holes (17) are connected by grooves (18).

14. A lipstick applicator according to claim 13, characterized in that the grooves (18) are in the range 0.2 mm to 1 mm deep and in the range 0.4 mm to 2 mm wide.

15. A lipstick applicator according to claim 1, characterized in that it is produced in a single piece from a synthetic material.

16. A lipstick applicator according to claim 15, characterized in that it is produced from a semi-flexible or flexible synthetic material.

17. A lipstick applicator according to claim 15, characterized in that it is produced from a transparent or translucent synthetic material.

18. A lipstick distributor, characterized in that it comprises a reservoir (2) for lipstick in the form of a paste provided with an applicator (3) according to claim 1.

19. A lipstick distributor according to claim 18, in which said applicator comprises a lower end (6) forming a flange (6′) having the same diameter as said reservoir (2).

20. A lipstick distributor according to claim 18, comprising a cap (2′) which can cooperate in a typical sealed manner with said applicator or said body.

21. A lipstick distributor according to claim 20, in which said cap (2′) abuts against said flange (6′) when said cap (2′) cooperates with said applicator (3) in a typical sealed manner to prevent the lipstick from drying out.

22. A lipstick distributor according to claim 18, in which said reservoir (2) comprises a radial projection (24) cooperating with said flange (6′) to fix said applicator to said reservoir (2).

23. A lipstick distributor according to claim 18, comprising a means for axial snap-fitting the applicator (3) to the reservoir (2).

24. A lipstick distributor according to claim 23, in which the applicator (3) comprises two flanges, a lower flange (6′) and an upper flange (6″) axially offset to lock the radial projection (24) of said reservoir (2) by axial snap-fitting of the assembly formed by the applicator (3) and its cap (2′) with the reservoir (2) once the latter has been filled from the top, to form said axial snap-fitting means.

25. A distributor according to claim 23, in which the reservoir (2) comprises two radial projections, an upper radial projection (24) and a lower radial projection (24′), to lock the flange (6) of the applicator by axial snap-fitting of the assembly formed by the applicator (3) and its cap (2′) with the reservoir (2) once the latter has been filled from the top, to form said axial snap-fitting means.
